(19) United States
(12) Patent Application Publication
(10) Pub. No.: US 2012/0241008 A1
(43) Pub. Date: Sep. 27, 2012

(54) APPLICATION OF TREATMENT FLUIDS TO COMPONENTS

(75) Inventors: David W. MILLS, Bewley (GB); Daniel CLARK, Belper (GB)

(73) Assignee: ROLLS-ROYCE PLC, London (GB)

(21) Appl. No.: 13/418,986

(22) Filed: Mar. 13, 2012

(30) Foreign Application Priority Data
Mar. 24, 2011 (GB) 1104928.5

(51) Int. Cl. B05C 5/00

(52) U.S. Cl. 137/1; 137/599.01

(57) ABSTRACT

A device for applying a treatment fluid to a target includes an application chamber that defines a substantially laminar application flow path from an inflow region to an outflow region of the application chamber; and a distribution chamber that communicates with the application chamber at an interface, in use, fluid being delivered from the distribution chamber to the application chamber via the interface across the full extent of the inflow region of the application chamber. A process for applying treatment fluid to a target region of a component surface using a treatment device operable to present the treatment fluid to the component surface is also disclosed. The process comprises introducing the treatment device to the target region of the component surface, and drawing treatment fluid through the device, across the target region of the component surface solely under the action of reduced pressure applied at an outlet of the device.

The present invention relates to improvements in the application of treatment fluids to components. More particularly, the present invention provides apparatus, processes and systems for the application of a treatment fluid to a target region of a component. Such a treatment fluid may for example include a chemical etchant.

### BACKGROUND

Chemical etching is a commonly used technique for removing one or more surface layers from a metallic component. An acid, base, or other chemical etchant fluid is applied to a component for a period of time and dissolves a surface layer of the component. Pre treatment of the surface to be etched is required, using a suitable scale conditioning fluid, following which the surface must be washed in preparation for the etching process. A further wash of the component surface is required once the etching process is complete. Chemical etching is widely used in the aerospace industry for the surface treatment of large components.

Aerospace engines commonly incorporate fan blades or aerofoils into their supporting discs to form a unitary component known as a blisk. The aerofoils are typically Linear Friction Welded onto the disc to avoid the excess weight associated with Fir Tree Roots and non permanent fixings. During normal operation, blisks are susceptible to damage and may require repair or refurbishment operations to prolong their useable life. Necessary repairs are often localised, for example only a very small number of blades on a blisk may require repair. Indeed, damage may be limited to only a particular region, such as for example the leading edge region, of a single blade on a blisk. Repair operations may include direct metal deposition and are likely to be followed by some form of localised heat treatment to relieve the stress of the repair. A localised layer of alpha-case may be formed on the surface of the component during the course of these processes and must be removed before the component is returned to service, as its presence can affect the fatigue life of the component. Chemical etching is the preferred method for removal of localised alpha-case layers on repaired blisks.

Conventional chemical etching of blisks is accomplished using large processing tanks, or etch tanks, within which an entire component may be submerged for a predetermined period of time, until the required surface thickness has been removed from the component. The use of etch tanks is associated with several disadvantages, including difficulties with process accuracy and effectiveness, inefficiencies of time and resources and issues relating to the health, safety and the environmental impact of the procedure.

With reference to the accuracy of etch tank processes, it will be appreciated that an etch tank is only capable of treating an entire component, regardless of the fact that only a very localised area of the component may require treatment. Not only does this result in the use of greater quantities of etchant chemicals than is necessary, but the process removes surface material in areas of the component where such removal is unnecessary and may be detrimental to component performance. Additional finishing processes are required to return the entire component to an acceptable surface finish as opposed to just the small area that actually required treatment. In addition, complex features that have been machined to close tolerances will be adversely affected, meaning a component may not fit and interact as precisely with its adjacent components following a global etchant treatment cycle.

It may be possible to mask the parts of a component that do not require treatment, but this involves additional process stages for the application and removal of the mask, adding time and cost to the process. Mask removal typically also requires the use of a solvent (which may be an organic chemical) and this introduces HS&E issues concerning handling, emissions and disposal.

Errors in accuracy also arise as a result of difficulty in closely controlling the temperature of etchant fluid in a large tank, which should be kept to a specific target temperature within the range 10 to 40° C. A large tank is slow to react to external temperature controls as well as to exothermic effects of the etchant reaction itself. Temperature fluctuations over a treatment cycle and between treatment cycles lead to inconsistencies in surface material removal. Such inconsistencies also arise in scale conditioning pre treatments that must also be accurately controlled at considerably higher temperatures.

The large quantity of etchant fluid required to fill a tank ensures that such fluid must be reused for the treatment of many components before it is sent for disposal. Titanium ions are dispersed into the fluid with each etchant cycle, continuously reducing the etchant potential of the fluid. Despite attempts to control the chemical degradation of the fluid with additives, variation in etchant potential between treatment cycles remains and causes variation in the amount of surface material removed. The lack of any form of real time feedback means that processing time must be calculated based on an assumed etchant potential of the fluid. Variations in material removal can only be discerned using component mass analysis after treatment to gain an idea of average material removal over the entire component surface. Post treatment analysis may come too late if an excess of material has already been removed, or may indicate that costly retreatment is required. With such challenging conditions and lack of real time feedback and control, compliance with tightly monitored sizing tolerances is difficult to achieve.

With respect to the inefficiencies inherent in the use of etch tanks, it will be understood that the large quantities of chemicals required, the significant surface areas necessary to accommodate processing tanks and the associated equipment for tank cleaning and for transferral of components between tanks all carry high costs in capital expenditure, maintenance and daily running. Temperature control of large fluid tanks involves high energy usage and in addition, specialist waste disposal together with highly skilled operators must be provided. Transport of components between pre-treatment, wash and etch tanks takes time and risks damage to the component, particularly as attachment fixtures may become worn or modified during the etchant process.

The significant quantities of chemicals employed in etch tank processing generate associated quantities of potentially hazardous gas and fluid emissions that must be disposed of, imposing a high environmental cost. In addition, etch tanks are necessarily open to the atmosphere, with significant cleaning and transportation structures arranged above them. Uncontained potentially hazardous chemicals and their associated infrastructure require designated health and safety equipment that must be purchased and maintained, as well as the sealing off of significant areas assigned to their use and the training of maintenance and support staff. The uncontained nature of etch tanks also places limitations on the manner in which certain processing chemicals may be used. For example, the optimal operating temperatures for scale conditioning fluids may be associated with health and safety risks that are unacceptable in the open environment of an etch tank facility.

In an effort to address some of the disadvantages noted above with respect to etch tanks, apparatus for targeted surface treatment has been developed as disclosed for example in US2008/0035179. According to this targeted method, etchant paste is delivered to a region of a component via a cassette which is clamped onto the component. While this may address some of the issues associated with etch tanks, it also carries disadvantages. Sealing of the cassette around areas of curvature on a component is problematic; it is difficult to produce a reliable leak proof seal on aerofoils of complex geometry.

The known local etchant cassette is also subject to the build up of hydrogen which is evolved in the form of bubbles as a by-product of the etchant chemical reaction. Hydrogen bubble formation during the known etch tank process is normally removed due to buoyancy, although smaller bubbles with low buoyancy may in some instances cause problems as they stick to the surface of the component and block etchant from interacting with the surface of the component. This problem becomes more apparent within a cassette owing to the smaller quantity of etchant fluid and the limited possibilities for gas to escape from the enclosure. Hydrogen bubble formation within the local etch cassette may therefore result in localised regions of alpha-case containing material remaining on the component surface. Additionally, the congregation of hydrogen bubbles poses a risk of explosion, system burst or acid expulsion, and consequent health, safety and environmental (HS&E) concerns. Specialised fixing methods are required to allow for hydrogen build up removal and for the removal of air pockets during filling of the cassette with the required wash, scale conditioning and etchant fluids.

The local etch cassette still suffers from issues of accuracy owing to inadequate etchant mixing. A build up of titanium ions between the etchant fluid and the component surface can cause the etchant reaction to end prematurely, leading to insufficient surface material removal and retreatment, and also making inefficient use of etchant fluid, adding to the expense of the process and increasing the HS&E burden. Inefficiencies of time and resources are also apparent in the lack of processes for effectively cleaning and removing spent fluid from the cassette and the need to dispose of still active etchant fluid.

The local etch cassette introduces fluid into the cassette under the application of positive pressure, and also relies on this positive pressure to agitate the fluid for efficient etching. Pressurising a highly acidic etchant is not regarded as good HS&E practice as the positive pressure places an increased burden on the sealing between cassette and component surface, leading to an increased risk of etchant escaping from the cassette. Escaped etchant fluid can flow over the component surface, causing undesirable cosmetic defects and increasing the risk of direct operator contact with the etchant fluid.

While providing targeted application of treatment fluid to a component, the local etch cassette is still comparatively unwieldy, requiring a large amount of space to accommodate both the cassette and the necessary clamping equipment to seal the cassette to the component. The cassette is therefore suitable only for treatment of a single aerofoil at a time, the tight spacing between blades on a blisk prohibiting simultaneous treatment of several blades.

The present invention seeks to address some or all of the above noted disadvantages with known techniques for the application of a treatment fluid to a component.

### SUMMARY OF INVENTION

According to the present invention, there is provided a device for applying a treatment fluid to a target region of a component, the device comprising: an application chamber that defines a substantially laminar application flow path from an inflow region to an outflow region of the application chamber; and a distribution chamber that communicates with the application chamber at an interface, in use, fluid being delivered from the distribution chamber to the application chamber via the interface across the full extent of the inflow region of the application chamber.

The interface may extend laterally across the full extent of the inflow region of the application chamber.

The interface comprises a manifold, which may be in the form for example of a flow guide or arrangement of pipes. The distribution chamber itself may comprise a manifold.

The interface may comprise a distribution element.

The device may further comprise means for application of pressure at the outflow region of the application chamber that is less than ambient pressure. The resulting reduced pressure operation enables the device to be self sealing and avoids the need for additional clamping apparatus. Reduced pressure operation also renders the device inherently safe, without the risks associated with pressurisation of treatment fluids such as scale conditioners and etchant pastes.

The device may further comprise a fluid inlet opening into the distribution chamber and defining an inlet flow path. The inlet flow path may be substantially parallel to the application flow path.

The distribution chamber and inflow region of the application chamber may cooperate to turn fluid flow received from the inlet through substantially 180 degrees before it is delivered onto the fluid application flow path. This turn through approximately 180 degrees assists in convenient application of the device to a component and also enables the device and associated pipe work to be as thin as possible, facilitating treatment in confined areas of a component.

The distribution element may comprise a perforated wall that divides the distribution chamber from the inflow region of the application chamber.

The inflow region may be oriented at substantially 90 degrees to the laminar application flow path.

The distribution chamber may be divided into two sub chambers by a second distribution element. The twin sub chamber arrangement also enables the device to be as thin as possible and may assist with turning the treatment fluid flow path through an angle between inlet and application chamber.

The second distribution element may comprise a perforated wall and may be at substantially 90 degrees to the first distribution element.

The lateral extent of the application chamber and laminar application flow path may be defined by peripheral seals, which may be operable to engage a component surface or a cooperating seal.

The peripheral seals may also bound the inflow and outflow regions of the application chamber to completely define the extent of the application chamber in the plane of the component surface.

The device may further comprise a consolidation chamber that communicates with the outflow region of the application chamber via a consolidation element.

The consolidation element may comprise a perforated wall.

The device may further comprise a fluid outlet that is operable, in use, to receive fluid from the consolidation chamber and discharge it from the device.

The outlet may be operable for connection to a reduced pressure pump

The device may comprise first and second treatment units, each treatment unit comprising a separate application chamber.

Each application chamber may communicate with the distribution chamber via a separate distribution element. Each treatment unit may comprise a separate consolidation chamber and corresponding fluid outlet. Each treatment unit may comprise a separate distribution chamber communicating with the corresponding application chamber via a distribution element.

Each distribution chamber may have a corresponding fluid inlet

Each application chamber may communicate with the consolidation chamber via a separate consolidation element. Each treatment unit may comprise a separate consolidation chamber communicating with the corresponding application chamber via a consolidation element.

Each consolidation chamber may have a corresponding fluid outlet

The first and second treatment units may be joined by a hinge mechanism, which may be a living hinge, mechanical hinge or other type of hinge mechanism. The treatment units may be detachable from each other.

The device may comprise a bifurcated form, the first and second treatment units comprising arms of the bifurcated form.

The first and second treatment units may be independent of each other.

At least one peripheral region of the device may be shaped to accommodate a component.

The treatment device may be substantially free form internal moving parts.

The device may be formed from a suitable polymeric material.

According to another aspect of the present invention, there is provided a process for applying treatment fluid to a target region of a component surface using a treatment device operable to present the treatment fluid to the component surface, comprising: introducing the treatment device to the target region of the component surface, and drawing treatment fluid through the device, across the target region of the component surface solely under the action of reduced pressure applied at an outlet of the device.

The treatment device may comprise seals operable to engage the component surface under the action of the low pressure applied at the outlet.

The treatment device may be substantially free form internal moving parts.

The process may further comprise continuously circulating the treatment fluid through the device across the target region of the component surface under the action of the low pressure for a predetermined treatment time.

The process may further comprise mixing the treatment fluid as it enters and/or exits the treatment device.

The process may further comprise monitoring the fluid as it is drawn through the device.

The process may further comprise monitoring the gaseous content of the fluid as it exits the device.

The process may further comprise applying a sealant material to the target region of the component surface before introducing the treatment device.

The sealing material may comprise a wax. The sealing material may also comprise a polymeric etchant resistant adhesive tape (PTFE) which may be used in following processes as an indicator of which regions of the component have been treated.

The process may further comprise removing the treatment device after a predetermined period of time and washing the target region of the component surface once the treatment device has been removed.

The treatment fluid may be a material removal fluid, which may for example be a chemical etchant fluid.

The treatment device may be a treatment device according to the first aspect of the present invention.

According to another aspect of the present invention, there is provided a process for treating a target region of a component surface with a treatment fluid, comprising:

a) determining an amount of treatment fluid required to treat the target region;
b) feeding the determined amount of treatment fluid to a treatment device;
c) continuously circulating the treatment fluid through an applicator of the treatment device whilst applying the applicator to the target region; and
d) discarding the treatment fluid once the target region of the component surface has been treated.

Step (c) may further comprise mixing the treatment fluid as it is circulated.

The process may further comprise disposing of the treatment fluid once the target region of the component surface has been treated.

The treatment fluid may be a material removal fluid and may for example be a chemical etchant fluid.

Step (a) may comprise calculating a theoretical amount of treatment fluid required and adjusting the theoretical amount to allow for imperfect application conditions.

Step (a) may further comprise determining an amount of time required for the determined amount of treatment fluid to treat the target region of the component.

The target region of the component surface may be judged to have been treated when treatment fluid has been applied to the target region for the amount of time determined in step (a).

Mixing the treatment fluid may comprise agitating the fluid before and after each pass through the applicator of the treatment device.

Circulating the treatment fluid may comprise circulating the treatment fluid between a fluid reservoir and the treatment device.

Step (d) may further comprise neutralising the treatment fluid prior to discarding the treatment fluid.

The process may further comprise monitoring the progress of the treatment while circulating the treatment fluid and supplying progress data to a process control unit.

The treatment fluid may be delivered at a target temperature. The process may further comprise pre-treating the target region of the component with a pre treatment fluid at the target temperature.

The treatment device may be a device as disclosed in the present specification.

According to another aspect of the present invention, there is provided a system for treating a target region of a component surface with a treatment fluid, comprising:
a treatment fluid reservoir;
a treatment device, operable to receive treatment fluid from the treatment fluid reservoir and to apply treatment fluid to the component;
a holding fixture for supporting the component; and a sealable enclosure containing the treatment fluid reservoir, the treatment device and the holding fixture.
The treatment fluid may comprise a material removal fluid and may for example comprise a chemical etchant fluid.

The system may further comprise a plurality of treatment fluid reservoirs, each operable to receive a different treatment fluid.

The or each treatment fluid reservoir may comprise heating and/or cooling elements.

The system may further comprise mixing elements, positioned between the or each fluid treatment reservoir and the treatment device.

The fluid reservoirs may also include agitation elements to agitate the contents of the reservoir and ensure, for example, that inorganic viscosity enhancing media do not fall out of the fluid under gravity while the fluid is travelling at low velocity. Such agitation may also aid mixing within the reservoirs.

The system may further comprise a plurality of treatment devices. The or each treatment device may be a device as disclosed in the present specification

The system may further comprise at least one pump, operable to pump treatment fluid around the system.

The pump may be a reduced pressure pump.

The system may further comprise a global wash facility positioned within the enclosure and operable to wash the interior and contents of the enclosure.

The holding fixture may comprise a rotatable element, for supporting the component in a rotatable manner.

### BRIEF DESCRIPTION OF THE DRAWINGS

For a better understanding of the present invention, and to show more clearly how it may be carried into effect, reference will now be made, by way of example, to the following drawings, in which:—

FIG. 1 is a representative perspective view of a treatment device illustrating open and closed positions;

FIG. 2 is a representative perspective view of an alternative treatment device;

FIG. 3 is a schematic representation of fluid flow through an application unit of a treatment device;

FIG. 4 is a representative illustration of treatment fluid flowing through a treatment device that is not itself shown in the Figure;

FIG. 5 is a partial close up view of FIG. 4;

FIG. 6 is a representative view of a casing for a treatment device;

FIG. 7 is a simplified diagram of a fluid flow system;

FIG. 8 is a representative diagram of an enclosure showing an enclosure cleaning system;

FIG. 9 is a representative diagram of a cleaning apparatus; and

FIGS. 10 to 14 are diagrams illustrating process steps in the treatment of a component

### DETAILED DESCRIPTION OF EMBODIMENTS

The present invention seeks to provide an efficient and environmentally friendly means of automating surface treatment of a component through material removal. Through the use of an acidic etchant media, material removal of a metallic component is accomplished typically enabling a surface layer of between 0-20 μm to be removed in a single etchant cycle. This amount may be increased up to 100 μm through the use of multiple cycles or larger amounts of etchant being circulated for a greater period of time. The present invention is particularly suited to the treatment of an aerofoil of Ti-6Al-4V that has received a post-processing repair using Direct Laser Deposition and a subsequent localised heat treatment stress relief cycle. As a result of these processes, a layer of alpha-case is formed in the location of the repair. The present invention provides a reliable and repeatable means for the removal of such alpha-case layers in a specific location upon this type of aerospace component. The following description explains the invention with reference to the treatment of an aerofoil component that is formed as part of a blisk. However, it will be appreciated that the present invention is not limited to such application, and may be employed in the treatment of a range of metallic components across the aerospace industry as well as in the automotive and other industries.

The present invention concerns a device for the application of a treatment fluid to a component, a system for the surface treatment of a component and a process for the surface treatment of a component. It will be appreciated that the device, system and process may be employed together to beneficial effect in the targeted surface treatment of a component.

The treatment fluid referred to throughout the specification may be any treatment fluid such as, for example, water, detergent solutions, pre treatment fluids such as scale conditioners or etchant fluid pastes.

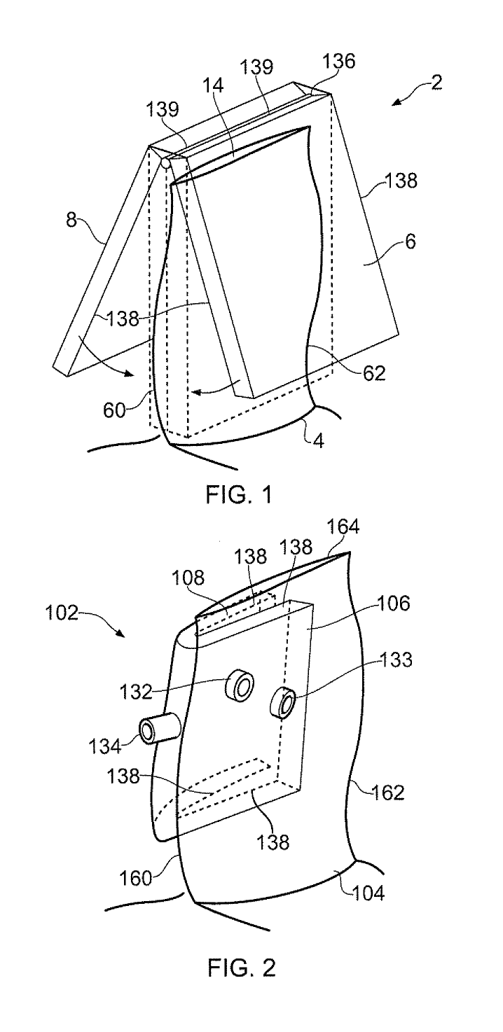

With reference to FIGS. 1 to 6, a device 2, 102 for applying a treatment fluid to a target region of a component 4, 104 comprises first and second treatment units 6, 8, 106, 108. Each treatment unit 6, 8, 106, 108 comprising an application chamber 110, 112, a distribution chamber 114, 116, which communicates with the application chamber 112 at an interface and may be divided into first and second distribution sub chambers 118, 120, 122, 124, a consolidation chamber 126, which may be divided into first and second consolidation sub chambers 128, 130, a fluid inlet 132, 133 and a fluid outlet 134. The treatment device 2, 102 is designed to accommodate a continuous flow of treatment fluid through the device from the inlet(s) 132, 133 to the outlet(s) 134.

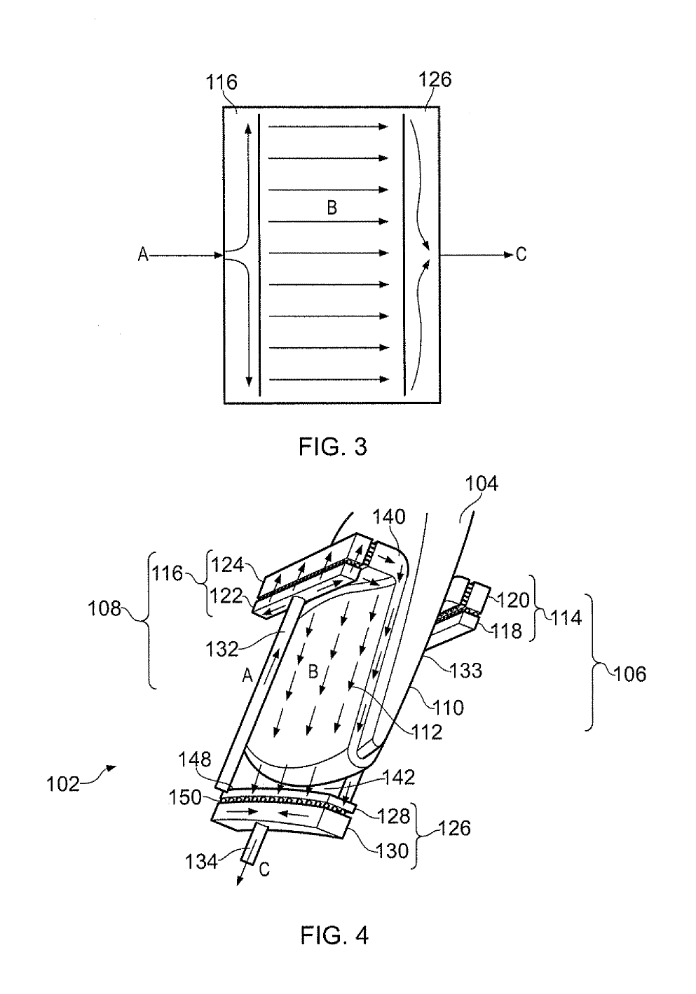

The two treatment units 106, 108 of the device may be integrally formed, as illustrated in FIG. 2, and may for example share a communal distribution chamber and inlet or consolidation chamber 126 and outlet 134. Alternatively, the two treatment units 6, 8 may be joined by a mechanical or living hinge mechanism 136, as illustrated in FIG. 1, each treatment unit 6, 8 having a dedicated fluid inlet and outlet (not shown). In a further alternative (not shown), the two treatment units may be entirely independent of each other. Detailed discussion of these alternatives follows below. Regardless of the external physical arrangement of the treatment device, the internal structure, and resultant fluid flow through the device, follow a consistent pattern, and will now be described in detail with respect to FIGS. 4, 5 and 3.

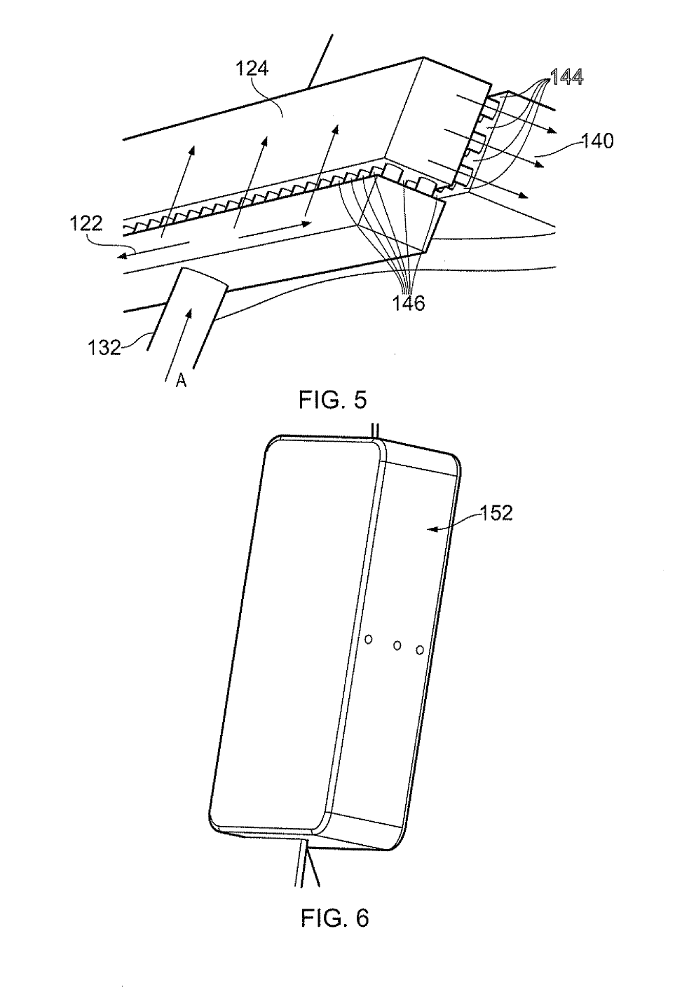

FIGS. 4 and 5 illustrate the physical form into which treatment fluid is constrained by the internal structure of the treatment device 102. Thus, the internal structure of the treatment device is not visible in FIGS. 4 and 5, but its geometry may be understood from consideration of the form into which the treatment fluid is constrained by the unseen internal structure. Internal structures within the treatment device are indicated by reference numerals associated with the location that the particular structures would occupy, were these structures visible. Chambers and other enclosures which are defined by internal structures and occupied by treatment fluid are indicated by reference numerals associated with the fluid shown as occupying the relevant chamber or enclosure. Much of the description is concerned with the treatment unit that is illustrated most clearly in FIG. 4. It will be appreciated however that corresponding structures can be found on the other treatment unit of the device 102, which is partially hidden in FIG. 4.

With reference to FIG. 4, the treatment unit 108 comprises an application chamber 112 that is open to the component 104 and in which treatment fluid is brought into contact with the component surface. The application chamber extends laterally between peripheral seals (illustrated at 138 on FIGS. 1 and 2) and extends along the component in a treatment flow direction from an inflow region 140 to an outflow region 142. First and second distribution sub chambers 122, 124 receive treatment fluid from the fluid inlet 132 and discharge fluid to the inflow region 140 of the application chamber 112. The first and second distribution sub chambers 122, 124 are arranged sequentially between the inlet 132 and the inflow region 140 of the application chamber 112. The distribution sub chambers 122, 124, and inflow region 140, extend laterally across the treatment unit to the full extent of the application chamber 112.

Dividing the inflow region 140 of the application chamber 112 from the second distribution sub chamber 124 is a distribution element in the form of a first perforated wall or baffle plate 144, A similar distribution element in the form of a second perforated wall or baffle plate 146 divides the first distribution chamber 122 from the second distribution chamber 124. The perforated walls 144, 146 extend across the full lateral extent of the distribution sub chambers 122, 124.

In use, treatment fluid is received along an inlet flow path A from the inlet 132 into the first distribution sub chamber 122, where it is able to spread laterally across the first distribution sub chamber 122. This spreading action is encouraged by the action of the second perforated wall 146 that restricts the freedom of fluid flow between the first and second distribution sub chambers 122, 124, forcing the fluid to seek out all possible apertures for passing between the first and second distribution sub chambers 122, 124. From the second distribution sub chamber 124, fluid passes through the first perforated wall into the inflow region 140 of the application chamber 112. The action of the first perforated wall 144 again forces the treatment fluid to seek out all possible apertures for passing into the inflow region 140 of the application chamber 112. The combined action of the two distribution sub chambers 122, 124 and perforated walls 144, 146 is to deliver treatment fluid evenly across the lateral extent and depth of the inflow region 140 of the treatment chamber 112. The treatment fluid then follows a treatment flow path B across the application chamber 112 (and hence across the surface of the component 104) that is substantially laminar, with little or no preferential or spreading flow. The lateral extent of the application chamber 112 is consistent along the chamber from the inflow region 140 to the outflow region 142 and is the same as the lateral extent of the distribution sub chambers 122, 124, assisting in providing uniform laminar flow along the treatment flow path B defined by the application chamber 112. At the furthest extent of the treatment flow path B, the treatment fluid is received into the outflow region 142 of the application chamber 112. From the outflow region 142, treatment fluid passes into first and second consolidation sub chambers 128, 130, through first and second consolidation elements in the form of perforated walls or baffle plates 148, 150. The first and second consolidation sub chambers 128, 130 are substantially analogous to the first and second distribution sub chambers 122, 124 and perform a reverse function. The consolidation sub chambers 128, 130 receive treatment fluid flowing in a laminar manner from the outflow region 142 of the application chamber 112 and discharge that treatment fluid into a single fluid outlet 134 to follow an outlet flow path C.

A schematic representation of fluid inlet, treatment and outlet flow paths is given in FIG. 3.

With particular reference to FIG. 4, the first and second perforated walls 144, 146 are oriented at 90 degrees to each other. In addition, the inlet flow region 140 of the application chamber 112 is oriented at 90 degrees to the rest of the application chamber 112. The combined effect of the two 90 degree orientations is to cause treatment fluid to flow around an angle of 180 degrees between the inlet flow path A and the treatment flow path B. The inlet and treatment flow paths are thus parallel but flowing in opposite directions. The outflow region 142, first and second consolidation sub chambers 128, 130, and outlet 134 are in alignment, meaning the outlet flow path C is in substantially the same plane as the treatment flow path B and flows in the same direction as the treatment flow path B.

In an alternative embodiment, illustrated in FIG. 3, the first and second perforated walls 144, 146, inflow region 140 and application chamber 112 are all in alignment, meaning the inlet and application flow paths A and B flow in substantially the same direction.

It will be appreciated that in the embodiment illustrated in FIG. 4, the first and second consolidation sub chambers 128, 130 are shared between the first and second treatment units 106, 108, such that the outflow regions of both application chambers 112, 110 discharge fluid into the same first consolidation sub chamber and from that chamber, treatment fluid from both treatment units flows to the second consolidation sub chamber 130 and out through the outlet 134. In the embodiment of FIG. 1, each treatment unit 6, 8 would have a dedicated consolidation chamber 126, which may consist of first and second consolidation sub chambers, and a dedicated outlet 134. In another alternative embodiment (not shown) the treatment units may share a common inlet and common distribution chamber that discharges into the two separate application chambers. Devices designed for treatment of smaller aerofoils may comprise single distribution and consolidation in each treatment unit, and may be designed for aligned flow paths, as illustrated in FIG. 3. Such devices provide operational flexibility, as the fluid flow direction through the device may be reversed, such that the original inlet becomes the outlet, and vice versa. This has particular advantages in seeking to minimise the effect of any turbulence induced by discontinuities at a repair site. If treating a trailing edge, it is desirable for treatment fluid to flow from the leading edge to the trailing edge, ensuring any induced turbulence is downfield of the repair location. Similarly, if treating an area on the leading edge, it is desirable for treatment fluid to flow from the trailing edge to the leading edge such that again any turbulence is downfield of the repair.

As illustrated in FIG. 6, each treatment unit comprises an outer casing 152 that encloses the internal structure of the treatment unit and may also carry the peripheral seals that define the extent of the application chamber 112.

The device 2, 102 can be sized according to the particular application for which it is intended. For example, as illustrated in FIG. 1, the device 2 may be sized to substantially encapsulate an aerofoil, enabling treatment of substantially the entire leading edge 60, trailing edge 62 and tip 64 of the aerofoil in a single cycle. According to this embodiment, peripheral seals 138 of each treatment unit 6, 8 seal against each other, as do peripheral seals at the top of the device 2 (as seen in FIG. 1). The base (as seen in FIG. 1) of the device may be shaped to accommodate the root of an aerofoil, with small surface variations being accounted for by base peripheral seals. Maskant material may be used to protect regions of the aerofoil not requiring treatment. Substantially encapsulating the aerofoil has the advantage of enabling treatment of several regions/repair locations in a single cycle. Alternatively, the device may be sized to treat a smaller localised area of an aerofoil, as illustrated in FIG. 2. Such a device is particularly suited to treatment of larger aerofoils and may be applied to any region of the leading edge, trailing edge or tip, or to a “picture frame” area of the pressure or suction faces of the blade as required. The device may also be moved to treat different individual areas on the aerofoil surface. Flexibility may be designed into the device to allow sealing against the complex and varying contours of a typical aerofoil.

Preferred embodiments of the device 2, 102, are sized to be as thin as is reasonably practicable in the direction of through component thickness. It will be appreciated that the 180 degree turn in fluid flow direction between inlet and treatment enables fluid inlets to be incorporated compactly into the treatment units, ensuring that when mounted on an aerofoil the device increases the thickness of the aerofoil as little as possible. This is particularly advantageous in the treatment of blisks, where several consecutive aerofoils on the blisk may need treatment and the reduced thickness of the device of the present invention ensures that consecutive, or at least alternate blades on the blisk can be treated simultaneously, affording considerable time savings when compared to the treatment devices of the prior art. Further advantages of the device of the present invention, and ways in which the device facilitates advantageous methods of treatment, are discussed in detail below.

The device is formed from a suitable polymeric material, its comparative simplicity and lack of moving parts ensuring that manufacturing costs for the device are kept to a minimum. If greater stiffness or support were required, the device could be formed in an alternative way; for example, the device could be formed of metal with a lining of suitable polymeric material.

An important advantage of the device of the present invention is that it enables a continuous laminar flow of treatment fluid to be directed over the component surface that is to be treated. The inlet(s) and outlet(s) of the device lend themselves to the application of a pressure gradient across the device, drawing fluid continuously through the device. Continuous flow of treatment fluid over the component surface ensures that an inactive layer of spent fluid cannot build up adjacent to the component surface; also the fluid can be continuously renewed, so that treatment is conducted with fluid of constant efficacy. In the case of etchant treatment fluid, the problems associated with hydrogen bubble formation upon the surface of the component are addressed. Any hydrogen evolved upon the surface is drawn out of the device and away from the component by the continuous movement of etchant fluid along the application chamber, and hence the component surface. The hydrogen is thus removed before bubbles have an opportunity to completely form. It is envisaged that any hydrogen removed during the process is discharged to waste or vented to the atmosphere.

The advantages afforded by continuous flow of treatment fluid through the device are reinforced by the mixing action of the distribution chambers and elements. The primary function of these components is to discharge fluid in laminar flow into the application chamber. However, these structures also serve an important secondary function in assisting in mixing of the treatment fluid to ensure even treatment of the component surface, whatever the nature of the treatment fluid.

Movement of treatment fluid through the device under the action of a pressure gradient is discussed above. In a preferred embodiment, this pressure gradient is formed through the application of reduced pressure at the device outlet(s). The entire device therefore operates under reduced pressure, fluid being drawn through the device under the action of the reduced pressure, rather than forced through by the action of increased pressure at an inlet.

A significant advantage afforded by reduced pressure operation is that the treatment fluid is never pressurised under normal service. The possibility of leakage or catastrophic release of treatment fluid is thus minimised and may be substantially eliminated. Should leakage at the device seals occur, air is pulled into the device rather than treatment fluid escaping. According to certain embodiments, the device casing and internal structure may be transparent, enabling any bubbles entering the device to be easily identified. Treatment fluid discharged from the cassette may also be examined for increased bubble content that might indicate inconsistent sealing.

Low pressure operation is also used to attach the device to the component being treated. Reliable sealing to the component is achieved through reduced pressure effectively sucking the cassette onto the surface of the component. The device may be shaped to allow for the transition between sealing against the component and sealing against an opposed treatment unit, with deformable peripheral seals accommodating minor irregularities and fluctuations in sizing. This provides significant advantages over the prior known devices which require an external clamp to apply a clamping force. Without the need for any external clamping component, the device of the present invention is much more compact and can be attached to a component even when component spacing is limited as for example in the case of fan blades mounted on a blisk. In use of the device, in order to enhance the sealing of the device onto a component, wax may be applied to the component surface prior to device attachment. The wax may be a chemically resistant compound, which may then be removed via an aqueous based wash as part of a cleaning process following the treatment.

Additional advantages of the device of the present invention include the self contained nature of the device and lack of moving parts. These considerably improve the HS&E cost of the device. Sealing is achieved through moulded deformable seals, which may be designed specifically to fit to targeted regions on a component and thus minimise crimping around the edges and reduce leakage. The deformable seals, coupled with low pressure sealing, also influence the profile shape of material removal during treatment with an etchant fluid, reducing generation of sharp edge step features that could provide nucleation points for fatigue defects to ensue.

With the device of the present invention, virtually any position on a component such as a blisk, drum or regular aerofoil can be treated on either side with minor adjustment. The device is particularly suited to treatment of an edge or tip of a blade, either in isolation or as a component part of a blisk.

The present invention also provides a system for the surface treatment of components, within which the treatment device of the present invention may be advantageously incorporated, and process by which surface treatment of components may be achieved. It will be appreciated that the treatment device of the present invention lends itself favourably to incorporation within a system, with multiple treatment devices being available for use at any given time in order to treat various aspects of a complex component substantially simultaneously. For example, and as described in the following embodiments of both system and process, an arrangement may be envisaged in which several devices are employed to facilitate the substantially simultaneous etchant surface treatment of multiple blades on a single aerospace blisk.

An important concept behind the system and process of the present invention, which is facilitated by the device of the present invention, is that each target region of a component should be treated with a single “shot” of treatment fluid. As discussed above, a major problem with etch tank treatment is that scale conditioning, wash and etchant fluids are continually being re-used, meaning the treatment potential of the fluids is continually changing and is never completely constant. According to the present invention, only a single small amount of fluid is used, enabling tight monitoring and control of the properties of that fluid throughout the treatment cycle.

Using the example of etchant treatment fluid, and in a preferred embodiment, the quantity of etchant fluid to be used is derived from calculations to assess under ideal conditions exactly how much etchant is required to remove a certain quantity of material. The actual amount of etchant required is roughly twice this calculated figure, owing to the impossibility of achieving perfect mixing conditions in a practical system. Time may also be introduced as a variable, the use of more etchant giving more material removal in an equivalent time. Material removal can thus be tailored to fit operational requirements using an appropriate blend of etchant quantity and process time. Even allowing for imperfect mixing conditions, the amount of etchant required will be orders of magnitude smaller than that required for a complete etch tank. This smaller amount of fluid can be much more finely controlled with respect to temperature, reactivity etc. The etchant required is continuously circulated through the treatment device and an etchant fluid reservoir, preferably undergoing mixing before and after passing through the reservoir. This ensures that the determined amount of etchant fluid is continually mixed, enabling the full etchant potential of the fluid to be exhausted in achieving the desired material removal. As the etchant cycle continues, the reactivity of the etchant is gradually reduced by the increasing concentration of metal ions distributed in solution through it. Consequently, by the time the cycle has finished, the etchant fluid is in a far safer and more environmentally friendly condition for waste disposal. Any remaining reactivity in the fluid can be neutralised and the fluid can be moved on to a treatment stage before being ecologically disposed of. Using only the necessary amount of etchant fluid also gives the system an element of “fail safe”.

It is an advantage of the present invention that each shot of etchant, or other treatment fluid, is substantially completely exhausted in a single treatment cycle, ensuring that a fresh shot is used for each cycle. In this manner, a measure of repeatability and consistency is introduced into the surface treatment process, as the chemical state of the treatment fluid at the start of each treatment cycle is consistent. Thus, variations in material removal between cycles and between components can be greatly reduced. In addition, greatly reduced quantities of etchant fluid are used in a far more efficient manner than has previously been possible, reducing the cost and environmental impact of the process.

It will be understood that the treatment device of the present invention lends itself advantageously to the implementation of this “one shot” concept. The device of the present invention ensures continuous circulation of fluid in a laminar manner across a component surface and can be used to ensure that all useful work has been achieved and the entire ‘shot’ of etchant has been utilised to its full potential in the allowed processing time. The constant mixing and recirculation of etchant ensures that minimum possible quantities of etchant are used to fulfil the required material removal in the allotted time. It will be appreciated that in the interests of process time and efficiency, a decision may be taken to halt the treatment process when substantially the entire shot of treatment fluid has been used. The advantage to be gained in utilizing the last few active ions may be judged insufficient to justify the process time required to ensure these last remaining ions are used.

The precise components of the system of the present invention can be varied according to the treatment process to be conducted. In the case of chemical etching of an aerospace component, the principle system components are:
at least one treatment device, preferably of the type described in the present specification
at least one etchant fluid reservoir
at least one scale conditioning reservoir
a warm wash reservoir
a warm holding reservoir
a cool wash reservoir
a cool holding reservoir
a waste reservoir
a neutralising fluid reservoir
connecting pipe work to enable circulation of fluid from any reservoir through the treatment device and to enable eventual discharge of fluid to any one of the holding or waste reservoirs
at least one low pressure pump to circulate fluid through the system
mechanical mixers positioned at entry and exit points of at least the etchant fluid and scale conditioning reservoirs

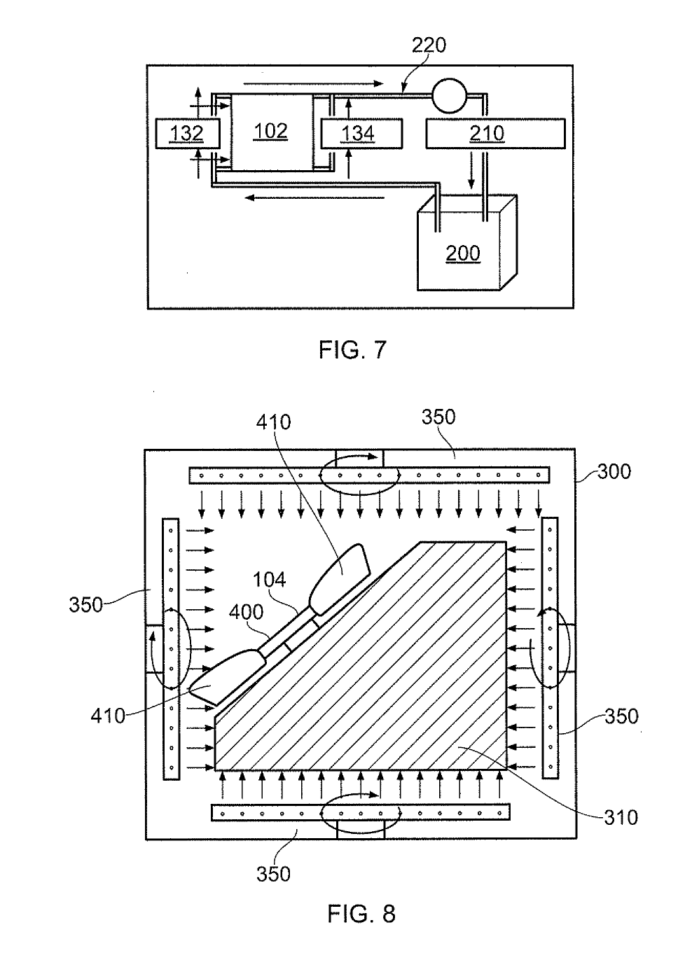

A simplified system is illustrated in FIG. 7, showing just the etchant reservoir 200, treatment device 102 with inlet 132 and outlet 134, low pressure pump 210 and connecting pipe work 220.

As indicated above, multiple mixing arrangements are employed throughout the system, for example at the entry to and exit from the etchant reservoir, to ensure that the etchant contains an equal distribution of titanium ions within solution at any one time. Mixers may also be located at the inlet of the treatment device, to assist the natural mixing action of the distribution chambers and distribution elements within the device. Effective mixing leads to a gradual decline in etchant reactivity, and hence material removal, until the cycle is brought to a close when the required amount of material has been removed.

The system components set out above are contained within an enclosure 300, together with a supporting fixture 310, on which the component 104 is mounted, and a global washing facility 350, as illustrated in FIG. 8. The enclosure 300 comprises a removable door or other opening that can be closed and sealed during operation. When in the open condition, the opening is sufficient to allow the fixture 310 to exit the enclosure 300, receive the component 104 and return within the confines of the enclosure 300 with the mounted component 104. The fixture 310 is tailored to the component 104 that is to be treated. For example, for treatment of a blisk 104 comprising a central disk element 400 and radiating blades 410, the fixture 310 is operable to support the blisk 104 on an inclined plane, the fixture being operable to rotate the blisk in a controlled manner about a fixed point on the plane such that any desired blade may be placed in any desired orientation within the plane. The rotational capability of the fixture allows the component to be rotated and effectively manipulated depending on the location on the component requiring repair. The system can thus take advantage of natural gravitational effects in filling and evacuation of the treatment device once mounted on the component. For example, during filling of the device with fluid, the component on which it is mounted can be oriented such that the inlet of the device is at substantially the lowest point of the device and the outlet is at substantially the highest point. The buoyancy of any air bubbles remaining in the device as it is filled will cause these bubbles to rise to the top of the device and be effectively evacuated under the low pressure applied at the outlet. During evacuation, the component on which the device is mounted can be oriented such that the inlet of the device is at substantially the highest point of the device and the outlet is at substantially the lowest point. Gravity thus assists in draining any last remaining fluid out of the device. In the case of a blisk 104 mounted on an inclined plane, filling and evacuation positions would thus constitute the 12 o'clock and 6 o'clock positions respectively. It will be appreciated that once filling of the device has been completed, the treatment cycle may continue unaffected by component orientation until device evacuation is required. Thus, for example, once a device has been mounted on a blade of a blisk and filled while occupying the 12 o'clock position, the blisk may be rotated to place the next blade requiring repair in the 12 o'clock position for filling of another treatment device while the treatment cycle continues on the first blade. A plurality of subsequent blades may have treatment devices filled in this manner while treatment on other blades continues unaffected by orientation. The same sequence may then be followed with evacuation of the various devices in the 6 o'clock position.

Robotic arms are automated to deliver treatment devices to the component and remove the devices when treatment cycles are finished.

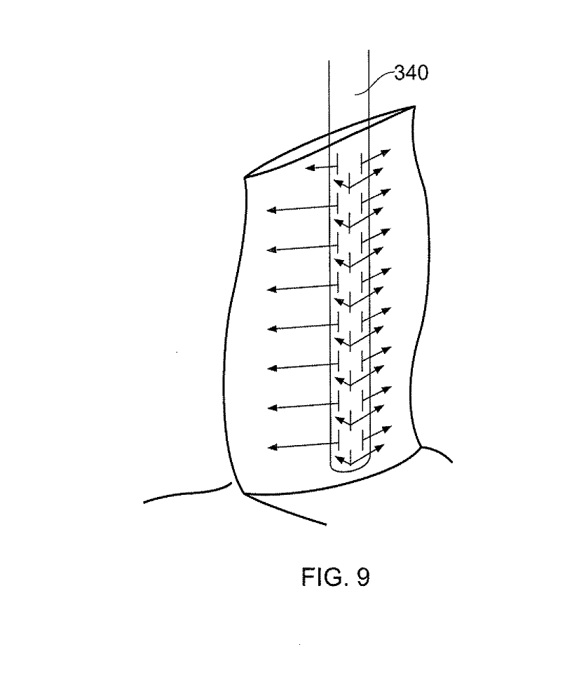

The global washing facility 350 within the enclosure 300 is capable of washing the entire enclosure and everything contained within it, including the fixture 310 and component 104. The washing facility 310 may comprise a plurality of rotating fluid jets, as illustrated in FIG. 8. Alternatively, some form of perforated hose may extend through the enclosure, as illustrated in FIG. 9. The washing facility 350 may include some form of bristle arrangement to assist with cleaning and may also comprise moving parts, enabling wash water jets to reach into complex component geometries for a thorough cleaning cycle.

Each of the fluid reservoirs within the system is provided with means for temperature control to ensure that the relevant fluids are delivered to the component at the correct operating temperatures. For example, heating elements are required for the scale conditioning reservoir and cooling elements for the etchant reservoir, at least to counteract the exothermic effect of the etchant reaction. The interior of the enclosure 300 may also comprise heating and cooling elements to allow temperature control of the component 104 within the enclosure 300. In this manner, the temperature of the component 104 may be substantially matched to the temperature of the treatment fluid to be used, enabling the treatment fluid to maintain its optimum operating temperature on contact with the component 104.

The entire treatment operation is managed by a control system. Within the control system are incorporated feedback loops, feedback sensors being incorporated into appropriate locations within the system components. In the case of a normal etchant cycle, these feedback sensors may monitor by products generated by the etchant process (which may for example be gaseous), metal ions present in the circulating etchant fluid, reactivity of etchant fluid, exothermic activity at the treatment surface etc. Such feedback sensors may enable the control system to monitor the progress of the etch cycle to ensure the cycle is stopped when precisely the correct amount of surface material has been removed. Taking the example of metal ion monitoring, ion distribution within the etchant fluid is calibrated to determine the relation between metal ion distribution and quantity of material dissolved into solution. The metal ion content can then be monitored until a level is reached that is representative of the desired amount of material removal. At this time, a neutralising solution is released into the etchant to prevent any further reaction. The neutralising solution has the additional advantage of rendering the etchant fluid safer and easier to dispose of in an ecological manner.

In another example, the quantity of hydrogen produced may be measured to provide feedback on the quantity of material removed by the etchant process and to add process control. The quantity of hydrogen evolved is linked directly to the material removal process, and may therefore be calibrated in a similar manner to metal ion levels in order to trigger release of a neutralising agent, and consequent ending of the etchant cycle, once the measured hydrogen levels indicate that the required amount of material has been removed.

System feedback can also include the monitoring of treatment fluid expelled from the treatment device for increased gaseous content. Should leakage be detected through increased quantities of gaseous product being pulled through the device, the control system causes instant evacuation and shut down of the device or devices in the safest possible manor. The process can then continue from the same stage in the treatment cycle once the issue has been resolved. Neutralising solution may also be released into the treatment fluid to neutralise and effectively shut down the treatment process in the event of an emergency or power cut. This facility may be linked to an emergency safety switch on the enclosure 300.

Regular calibration checks are advisable as a routine system requirement, as well as periodic mass-loss analysis to assess material removal, and confirm the accuracy of feedback monitoring and control. The result is a system that is tightly controlled and capable of removing precise quantities of material in a set period of time.

The system components are designed to be easily replaced with minimum system down time requirements. According to one embodiment, the control system includes means for counting the number of cycles each component goes through and for warning when a set of components are due for replacement. Such provisions reduce the running and maintenance cost burden of the system.

It will be appreciated that the system of the present invention is self contained, eliminating the need for operator contact with potentially hazardous treatment fluids, and is also computer controlled, reducing exposure to operator error and inconsistency. Known systems of targeted surface treatment rely on operator contact with the treatment device to apply new treatment fluid and remove used fluid. Whilst this process is relatively simple, it requires close operator contact with treatment fluids and relies upon operator control and accuracy for the overall accuracy of the treatment process. In contrast, the system of the present invention is housed within an enclosure 300. The enclosure 300 is provided with a micro-switch or other safety feature that prevents treatment fluid of any kind (including wash, scale conditioning and etchant fluid) from being pumped around the system when the enclosure 300 is open. Contained within the enclosure is global washing facility 350 angled to wash the treated component once the treatment device has been removed. Thus, the component not only enters the enclosure in a clean state but also leaves the enclosure in a clean state, all operations requiring contact with potentially hazardous fluids taking place within the confines of the enclosure 300. The HS&E measures required are greatly reduced by this close containing of all treatment material, and ensuring that the component is only released from the enclosure once it is again in a clean state. Even if a decision is taken to allow manual operators to place treatment devices on sections of the component to be treated, this can be done before the enclosure is sealed, and certainly before any treatment fluid is pumped through the devices. Thus, operator contact with potentially hazardous treatment fluids is completely avoided.

An advantage of the system of the present invention is that it significantly enhances the potential for multiple repairs on individual components. If a component undergoes a repair process using global etch tank processing, no further repair of that component will be possible, owing to the fact that the entire surface component will have undergone material removal, including high tolerance, critical features. By treating only a targeted region of the component, the present invention opens the possibility for multiple repair treatments, prolonging the life of a component. Known targeted etchant devices are designed specifically for the treatment of a single aerofoil on an aerospace blisk, aiming to eliminate the requirement to treat an entire component when it might be that only a single aerofoil requires treatment. The system of the present invention also facilitates treatment of a single aerofoil but in addition, it allows a multitude of aerofoils to be treated at any one time, thus saving both time and materials. The system of the present invention is thus extremely versatile with only minor adjustments required to process a wide variety of aerofoils and repair locations on consecutive aerofoils upon a blisk assembly. As discussed above, the design of the treatment device of the present invention enables the device to be made extremely thin. Connectivity of the device is also designed to facilitate usage of the device in limited spaces, allowing consecutive aerofoils on a single blisk to be treated substantially simultaneously. According to preferred embodiments of device and system, at no point do the treatment device and associated pipe work require more space than the midpoint between each aerofoil on a standard aerospace blisk assembly. Thus, with every aerofoil upon the assembly being concurrently treated, the equivalent processing time of one aerofoil is required to treat the entire assembly. Even in the event of treatment of components of complex geometries, where treatment of consecutive blades may not be possible, treatment time for the overall component is still greatly reduced.

Where contemporaneous treatment of several component features, such as aerofoils, is required, the treatment fluid reservoirs, including for example warm and cold wash fluid, scale conditioner and etchant fluid, may be charged with sufficient fluid to treat all component features. This arrangement saves considerable costs in reducing space, heating, cooling and materials requirements, as well as ensuring that the treatment potential of the fluid employed in all the treatment devices degrades at the same rate. Connecting pipe work and pumping arrangements may be provided to pump sufficient treatment fluids to the various treatment devices employed in the system. The treatment devices may be arranged in a series or parallel relationship. Fluid circulation may be constant throughout the system and one or more additional pumps may be employed in parallel to provide sufficient reduced pressure. The pumping power may be varied according to the number of treatment devices to be employed, and the consequent reduced power requirement. Alternatively, each component feature, such as each aerofoil on a blisk, may have a dedicated arrangement of reservoirs and associated dedicated treatment device, independent pumping arrangements being provided for each treatment device. In either case, rotation of the component upon the fixture dislodges trapped air, therefore providing suitable filling of the cassettes and the onset of continual replenishment.

If required, various stages of the treatment process may be allocated specific treatment devices. For example, in material removal of a targeted region of an aerofoil, one treatment device may be used to apply hot wash fluid and scale conditioner, while a second treatment device is used to apply cold wash fluid and etchant fluid.

A representative process for treating a component will now be described, in which the device and system of the present invention are employed to deliver attendant process advantages. The representative process involves the treatment of at least one aerofoil of Ti-6Al-4V that is mounted on an aerospace blisk assembly and has undergone a post processing repair and subsequent localised heat treatment stress relief cycle.

The treatment fluids involved include hot and cold wash fluids, a scale conditioner and an etchant fluid. The scale conditioner is for example an aqueous blend of caustic alkalis and inhibitors which may include sodium hydroxide and sodium chromate. Etchant fluids may include Hydrofluorosilicic (H₂SiF₆) and Nitric (HNO₃) acids, Hydrofluoric (HF) and Nitric (HNO₃) acids or a combination of the above. The etchant is mixed with an inorganic viscosity enhancing material, such as titanium dioxide, to increase the viscosity of the fluid and reduce the likelihood of leakage. Other materials of note for the enhancement of etchant viscosity include glycerol, aluminium oxide and other oxide-based inert powders, plus any water or solvent based gels.

Initially, the control system calculates the amount of surface material to be removed from the component, and hence the amount of etchant fluid required, in a process discussed more fully above. The scale conditioner and wash fluids are similarly assessed and the necessary fluids are loaded into their respective reservoirs.

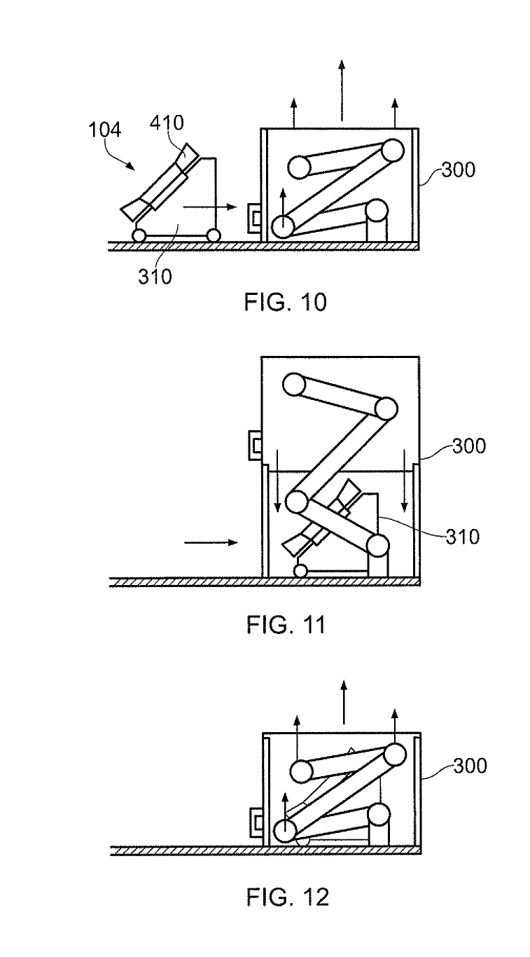

The enclosure 300 is then opened and the supporting fixture 310 removed to receive the blisk assembly 104, as illustrated in FIG. 10.

The fixture 310 is then returned to the enclosure 300, carrying the blisk assembly 104 and the enclosure 300 is closed and sealed, as shown in FIG. 11. The fixture 310 causes the blisk assembly 104 to rotate in the inclined plane in which it is mounted until the first blade 410 requiring treatment is in the 12 o'clock position.

Optionally, wax may be applied to the particular blades of the blisk assembly 104 that are to be surface treated, in order to assist with sealing of treatment devices 102 onto the blade surfaces.

A first treatment device 102 is then mounted onto the blade 410 occupying the 12 o'clock position on the blisk assembly 104 via an automated robotic arm. The device 102 is sealed onto the blade 410 by the application of low pressure and the seal is then tested and air pockets removed by automated filling of the device 102 with wash or test fluids. The orientation of the blade 410 on which the device 102 is mounted ensures that the inlet 132 of the device 102 is at the lowest point of the device 102 and the outlet(s) 133, 134 at the highest point. Thus as fluid is drawn into the device 102 by the low pressure applied at the outlet(s) 133, 134, the buoyancy of remaining air bubbles tends to force these air bubbles to the top of the device to be drawn out of the outlet(s) 133, 134, as described above in greater detail.

The device 102 is filled with heated wash fluid that circulates through the device 102, passing along the application chambers 112 and in so doing, degreasing the region of the blade 410 surface to be treated, removing contaminants and pre heating the component surface. This preheating effect is particularly beneficial; a high-temperature wash stage at 95° C. effectively prepares the component for the following high temperature scale conditioning stage, ensuring that the temperature does not drop when scale conditioning fluid is first introduced. This prevents waxy residue forming on the surface of the blade 410 and inhibiting reaction with the titanium surface of the blade should the temperature drop below specific values.

Once the wash stage is complete, the used wash fluid is evacuated from the device 102 and discharged to the warm holding reservoir. The device may then be flushed with hot clean water. The device 102 is then filled with heated scale conditioning fluid which circulates around the device 102 and between the device 102 and the scale conditioning reservoir. The scale conditioner effectively “softens” the titanium oxide layer that has been formed on the surface of the component and is to be removed. The scale conditioning fluid circulates for a predetermined time of, for example 60 minutes at a predetermined temperature of, for example 95° C.

On completion of the scale conditioning stage, the scale conditioning fluid is evacuated from the device 102 and discharged to the waste reservoir.

The device 102 and blade surface are then flushed with fresh hot water that is also discharged to the waste reservoir, diluting the scale conditioning fluid in the waste reservoir. A neutralising agent may be fed into the hot water to restore neutral pH balance. Following this warm fluid flush, the device and blade surface are flushed with cooled wash fluid that is then discharged to the cold holding reservoir. The cooled wash fluid helps to reduce the temperature of the blade surface to the optimum temperature for the etchant reaction.

The device 102 is then filled with etchant fluid that is circulated around the device, and between the device and the etchant fluid reservoir, until the etchant fluid is rendered substantially inactive by the presence of Ti ions. Continual mixing of the etchant fluid ensures a constant gradual decline in etchant reactivity. Continuous passage of etchant over the blade surface in laminar flow ensures no preferential etching and no inactive regions caused by build up of hydrogen or Ti ions.

Optionally, hydrogen evolved as bubbles during the etchant stage may be collected for storage or for venting to waste. Gaseous content of etchant discharged from the device 102 is monitored to check for evidence of leakage. The progress of the etchant stage is monitored via feedback loops registering Ti ion content of the etchant fluid, temperature, waste product production etc. Once feedback indicates that sufficient surface material has been removed, a neutralising agent is released into circulation with the etchant fluid to inactivate the etchant fluid and stop the etchant reaction. The mixed etchant fluid and neutralising agent are then evacuated and discharged to the waste reservoir. An etchant treatment stage may be conducted, for example at 20° C.±5° C. and for between 1 and 60 minutes.

Following the etchant stage, the device and blade surface are flushed with held warm wash fluid from the warm holding reservoir. This fluid is then discharged to the waste reservoir diluting the mixture of fluids held in the waste reservoir. The device and blade surface are then flushed with held cool wash fluid from the cool holding reservoir. This fluid is then discharged to the waste reservoir, further diluting the contents of the waste reservoir. A further wash with, de-ionised clean water may also be conducted and a neutralising agent released into the water to restore neutral pH balance.

The device is then removed from the blade surface via an automated robotic arm. The entire enclosure, including all the blades of the blisk assembly and the holding fixture, is then cleaned by the global cleaning facility. This cleaning removes any last traces of treatment fluids as well as any wax that may have been employed to aid sealing of the device 102 onto the blade surface. Enclosure cleaning water is also fed to the waste reservoir to further dilute the contents of the waste reservoir.

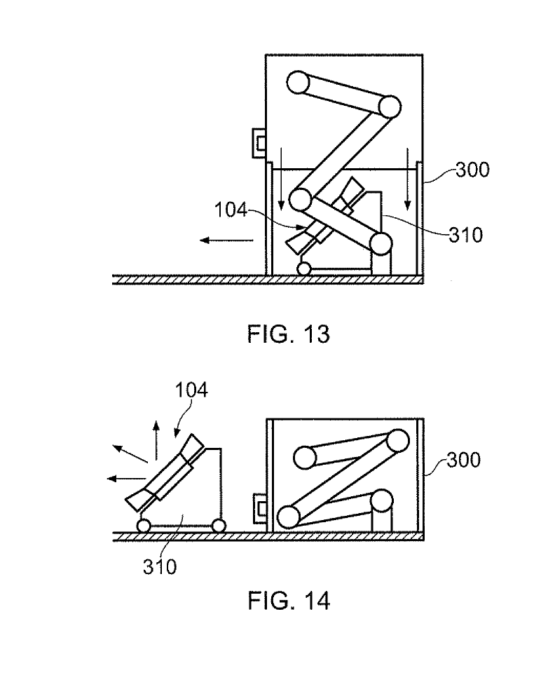

The enclosure is then opened and the holding fixture 310 and blisk assembly 104 removed, as illustrated in FIGS. 12 to 14.

In a variant of the above described process, the treatment device may be attached to the relevant blade before the enclosure is closed and sealed, either manually or by an automated process. Optionally, the blade may be treated with targeted regions of masking or etchant resistant material, to resist etching in certain areas.

In a further variant of the procedure, two treatment devices may be used to treat a single blade, one device for scale conditioning and preceding stages and a second device for all subsequent stages. During changeover of devices, the treated blade is kept wet by means of a sprinkler system or other appropriate apparatus within the enclosure.

It will be appreciated that, while treatment of a single blade on a blisk assembly has been described, similar processes may take place substantially contemporaneously to treat multiple blades on the same blisk assembly. All necessary treatment devices are mounted onto the relevant blades at the outset of the procedure. During the treatment process, continual rotation of the blisk assembly ensures that each device is in the correct orientation for filling and evacuation when required. During the various treatment stages, between filling and evacuation of the treatment devices, orientation of the treatment devices is irrelevant. In this manner several blades may be treated substantially simultaneously, filling of a device on a subsequent blade starting at the 12 o'clock position as soon as the previous blade has been rotated away from that position, its treatment stage underway.

The above described representative process emphasises how a component may enter the treatment enclosure clean and leave clean. This “all in one” design minimises cycle time, eliminates transport between process stages and the associated damage risk, and also eliminates operator contact with potentially hazardous fluids. Fluids are only released into circulation when enclosure closed and sealed, and the system can include a safety switch to ensure this is the case. The entire system is reduced pressure operated, making it fail safe, and instantaneous evacuation and shut down can be achieved in the event of leakage or other problems.

Temperature control is conducted on only the minimum amount of fluid required, reducing energy usage. Chemical cleaning of wash fluids between cycles may also be employed, meaning that fluid may be re used to reduce the environmental impact of heating and jettisoning excess detergent after initial use.

Variation in material removal between etchant cycles is substantially eliminated through the use of fresh “shots” of etchant fluid for each cycle, thus addressing a major problem associated with methods known in the art.

### SUMMARY OF ADVANTAGES

Representative embodiments of a device, system and process for the surface treatment of a component have been described. As discussed above, the present invention seeks to provide a safe, reliable and repeatable means of removing material from a targeted location upon a component, notably an aerofoil upon a single stage blisk or blisk drum assembly for use in the aerospace, power generation or marine industry. Aside from the inherent cost saving of localised etching as a part of blisk repair strategy, the present invention also uses significantly reduced quantities of etchant when compared with known immersion tank systems, with consequent reductions in waste and emissions. Parts requiring repair can be processed in a separate, self contained facility which components enter and leave in a clean state, thus reducing necessary HS&E provisions and requiring less insulation. The heating of scale conditioning fluids and cooling of etchant fluids is minimised saving energy. Waste is minimised and ecological disposal achieved through the use of ion exchange media, reverse-osmosis and gelatinous capture of waste products, ensuring that waste is effectively neutralised before disposal.

A major inefficiency of known processes is addressed by the present invention through the use of minimised quantities of etchant fluid to treat targeted regions upon a component. Using the device of the present invention, an application chamber may be sealed to a targeted region upon a component and filled with material removal chemical compositions. Global immersion of the component is avoided and material is removed only where removal is required, allowing the component to undergo more repairs, and hence prolonging the life of the component.

Fresh shots of etchant fluid used in each etchant cycle, together with continual mixing of etchant fluid, provide consistency of material removal across cycles. Continuous passage of fluid over the component surface in a laminar manner aids consistency and efficiency of material removal and avoids preferential etching.

Further advantages of the present invention include the following:
Accommodation of component contour and curvature, including any deviation resulting from material addition and stress relief processes.
Reduced cost and ease of shielding owing to compact sizing: reduced pressure operation ensures that etchant cannot escape from the treatment device unless a major mechanical failure occurs, in which situation the system auto evacuates and shuts down.
Reduced energy usage in heating/cooling: scale conditioning heat is conserved through a heated wash cycle. Minimal delay between processes allows limited time for heat dissipation and the compact nature of the system renders it easy to insulate.
Time saving through simultaneous treatment of several parts of a component.
Ease of waste disposal owing to the efficient use of chemicals.
Space saving owing to the compact nature of the system and device.
One shot usage eliminates the need for daily chemical analysis and chemical compensation for variation in etchant reactivity, saving costs on chemical analysis and equipment and associated operator time.
Contained system reduces HS&E burden and factory footprint.
Contained system also facilitates use of process chemicals at optimum temperatures, the increased containment and consequent facility to process potentially hazardous emissions enabling management of any increased HS&E risk associated with the optimum temperatures.
Versatility for adaptation to different components and operational requirements.
Reduced processing time owing to efficient chemical usage and system design.
Accommodation of comparatively rough surfaces such as as-welded DLD material addition regions. The design of the treatment device ensures material removal from rough regions remains equal throughout processing; ensuring the device does not distinguish between rough and smooth surfaces but ensures constant material removal.

Variations to the particular embodiments described herein may be contemplated within the scope of the present invention. For example, the apparatus of the present invention may be employed as part of the following NDT stages: Initial Wash, Pre-Material Addition NDT Etch, Pre-Material Addition NDT Die-Penetration, Post-Material Addition NDT Etch and Post-Material Addition NDT Die-Penetration.

Alternative processes for scale conditioning and/or material removal may be harnessed using the device, apparatus and process of the present invention. These may include NaOH Anodising, Air/O₂ Plasma Treatment and Sol-Gel Treatments.

Additional reaction stimuli may be incorporated into the apparatus, and the physical geometry of the apparatus may be adapted for treating a wide range of components, including for example drums. Heating and/or cooling pipe work may be built into the apparatus to aid in temperature control. Heating and/or cooling jackets may be built around circulatory pipe work, or a radiator could be incorporated, also to aid temperature control.

Although automated control is preferred, the apparatus of the present invention could be operated manually. Depth probes, surface scanners and/or surface analysers may be incorporated into the treatment device of the present invention. Oscillation may be introduced by the incorporation of ultrasound.

The present invention has been described with particular reference to the post repair treatment of an aerofoil. However, it will be understood that the invention may find a range of applications across the aerospace and other industries. For example the invention may be used for NDE preparation, cleaning prior to material addition, or Diffusion bonding. NDE applications may include Dye Penetrant Inspection, in which treatment is required to remove material that may have been added over pre existing cracks during machining or post processing following manufacture. The invention could also be used to provide surface preparation for a particular surface finish standard, or to conduct large scale glass etching or marking. Chemical milling without a masking stage can also be performed.

1. A device for applying a treatment fluid to a target region of a component, the device comprising: an application chamber that defines a substantially laminar application flow path from an inflow region to an outflow region of the application chamber; and a distribution chamber that communicates with the application chamber at an interface, fluid being delivered in use from the distribution chamber to the application chamber via the interface across the full extent of the inflow region of the application chamber.

2. A device as claimed in claim 1, wherein the interface extends laterally across the full extent of the inflow region of the application chamber.

3. A device as claimed in claim 1, wherein the interface comprises a distribution element.

4. A device as claimed in claim 1, further comprising means for application of pressure at the outflow region of the application chamber that is less than ambient pressure.

5. A device as claimed in claim 3, wherein the distribution element comprises a perforated wall that divides the distribution chamber from the inflow region of the application chamber.

6. A device as claimed in claim 3, wherein the distribution chamber is divided into two sub chambers by a second distribution element.

7. A device as claimed in claim 1, wherein the lateral extent of the application chamber and laminar application flow path is defined by peripheral seals, operable to engage a component surface or a cooperating seal.

8. A device as claimed in claim 1, further comprising a consolidation chamber that communicates with the outflow region of the application chamber via a consolidation element.

9. A process for applying treatment fluid to a target region of a component surface using a treatment device operable to present the treatment fluid to the component surface, comprising:
introducing the treatment device to the target region of the component surface, and
drawing treatment fluid through the device, across the target region of the component surface solely under the action of reduced pressure applied at an outlet of the device.

10. A process as claimed in claim 9, wherein the treatment device comprises seals operable to engage the component surface under the action of the low pressure applied at the outlet.

11. A process as claimed in claim 9, further comprising continuously circulating the treatment fluid through the device across the target region of the component surface under the action of the low pressure for a predetermined treatment time.

12. A process as claimed in claim 9, further comprising mixing the treatment fluid as it enters and/or exits the treatment device.

13. A process as claimed in claim 9, further comprising monitoring the fluid as it is drawn through the device.

14. A process as claimed in claim 9, further comprising monitoring the gaseous content of the fluid as it exits the device.

15. A process as claimed in claim 9, further comprising applying a sealant material to the target region of the component surface before introducing the treatment device.

16. A process as claimed in claim 9, further comprising removing the treatment device after a predetermined period of time and washing the target region of the component surface once the treatment device has been removed.

17. A process as claimed in claim 9, wherein the treatment device is a device for applying a treatment fluid to a target region of a component, the device comprising: an application chamber that defines a substantially laminar application flow path from an inflow region to an outflow region of the application chamber; and a distribution chamber that communicates with the application chamber at an interface, fluid being delivered in use from the distribution chamber to the application chamber via the interface across the full extent of the inflow region of the application chamber.
